(19) United States
(12) Patent Application Publication
(10) Pub. No.: US 2012/0194651 A1
(43) Pub. Date: Aug. 2, 2012

(54) Shape measuring apparatus

(75) Inventors: Kenta Kanto, Tokyo (JP); Seiho Yamashita, Kawasaki-shi (JP); Takeshi Endo, Yokohama-shi (JP)

(73) Assignee: NIKON CORPORATION, Tokyo (JP)

(21) Appl. No.: 13/200,652

(22) Filed: Sep. 28, 2011

Related U.S. Application Data
(60) Provisional application No. 61/457,210, filed on Jan. 31, 2011.

(51) Int. Cl. H04N 13/02

(52) U.S. Cl. 348/50; 348/E13.074

(57) ABSTRACT

[PROBLEMS] To provide a shape measuring apparatus having a configuration which enables the operation for aligning a measuring probe and a candidate object to be simplified when the shape of the candidate object is measured.

[MEANS TO SOLVE THE PROBLEMS] A shape measuring apparatus is configured so that an optical probe 20 moves relative to a candidate object, and the three-dimensional shape of the candidate object is measured without contact from information obtained by the optical probe 20. The shape measuring apparatus includes a gantry structure 10 allowing the optical probe 20 to be moved to a predetermined position relative to the candidate object, and a support device 30 allowing the candidate object to be rotated around at least two rotational axes.

### TECHNICAL FIELD

The present invention relates to a noncontact shape measuring apparatus for imaging a candidate object using an imaging device such as a CCD, and measuring the contour shape and other attributes of the candidate object from the resulting images.

### TECHNICAL BACKGROUND

Methods for measuring the three-dimensional shape of a candidate object without contact include light sectioning, in which the object to be measured is irradiated with slit light and the three-dimensional shape of the object is measured from the light sectioning rays formed correspondingly with the cross-sectional shape of the object (e.g. PATENT DOCUMENT 1), and lens focusing (shape-from-focus method) in which the optical distance to a candidate object is changed and the three-dimensional shape of the candidate object is measured from the focus information in a plurality of images.

Apparatuses for performing such noncontact shape measurements are configured so that a measuring probe on which an imaging device using a light exposure system has been mounted and a support device for supporting the candidate object are able to move relative to each other along three mutually perpendicular axes (the X, Y and Z axes). In such instances as when a measurement point for automatic measurements is taught, the movement is controlled independently along the axes using an operating device such as a joystick in order to move the measuring probe to the desired position relative to the candidate object and align the two.

### PRIOR ARTS LIST

### Patent Document

[PATENT DOCUMENT 1] Japanese Laid-Open Patent Publication No. H5-272927

### SUMMARY OF THE INVENTION

### Problems to be Solved by the Invention

However, when the measuring probe and candidate object are positioned using this type of shape measuring apparatus, an operating device such as a joystick has to be used to move the measuring probe and the candidate object relative to each other along the X, Y and Z axes in order to align the viewpoint of the measuring probe with the measurement position of the candidate object. Unfortunately, difficulties have sometimes been presented in regard to optimizing the orientation of the measuring probe relative to a measured portion of the candidate object due to the shape of the candidate object; and, in the past, operations performed for aligning the measuring probe and the candidate object have been complex, increasing the amount of time for measuring the shape of a candidate object.

The present invention has been made in view of the above problems, and an object thereof is to provide a shape measuring apparatus having a configuration which enables the operation for aligning a measuring probe and a candidate object to be simplified when the shape of the candidate object is measured.

To solve the problem, the present invention is a shape measuring apparatus configured so that a measuring probe is caused to move in a relative manner with respect to a candidate object, and a three-dimensional shape of the candidate object is measured in a non-contact manner from information obtained by the measuring probe, the shape measuring apparatus comprising: a movement device for moving the measuring probe to a desired position with respect to the candidate object, and a support device for rotating the candidate object around at least two rotational axes.

According to the aforedescribed invention, it is preferable that the support device has a stage portion on which the candidate object is mounted. causing the stage portion to rotate around a first rotational axis extending perpendicular to the mounting plane enables the candidate object to be rotated within a horizontal plane, and rotating the stage portion through the first rotational axis and around a second rotational axis perpendicular to the first rotational axis enables the candidate object to be tilted relative to the horizontal plane.

According to the aforedescribed invention, it is also preferable that the movement device has a drive mechanism for translating the measuring probe along three mutually perpendicular axes.

According to the aforedescribed invention, it is also preferable that the movement device comprises a base for holding the support device, a pillar able to move along an in-plane direction of a holding surface on the base, a frame extending in a direction perpendicular to a direction in which the pillar is able to move and extending in a direction parallel to the in-plane direction, and a carriage for holding the measuring probe movably in a direction perpendicular to the moving direction and the extending direction, the carriage being able to move in the extending direction of the frame. In this aspect, the pillar, carriage and measuring probe are driven by the drive mechanism.

According to the aforedescribed invention, it is also preferable that the measuring probe comprises a camera and an image processor for processing a signal outputted from the camera, the camera having an image optics system for taking an image of the candidate object. According to the aforedescribed invention, the measuring probe can have an light sectioning probe equipped with a slit light illumination unit for irradiating the candidate object with slit light in the shape of a sheet, and a camera whose optical axis is arranged at a predetermined angle relative to the direction of the slit light for imaging the candidate object irradiated by the slit light.

### Advantageous Effects of the Invention

According to the present invention, it is possible to perform straightforwardly the task of aligning a measuring probe and a candidate object, making it possible to reduce the time for the candidate object to meet the measurement conditions of the shape measuring apparatus.

### BRIEF DESCRIPTION OF THE DRAWINGS

FIG. 1 is a schematic view used to describe control of relative movement in a three-dimensional shape measuring apparatus according to the first embodiment of the present invention;

FIG. 2 is a view used to describe control of relative movement around the X axis of the optical probe and the candidate object in the first embodiment;

FIG. 3 is a view used to describe the amount of tracking movement by the optical probe during control of relative movement around the X axis of the optical probe and the candidate object in the first embodiment;

FIG. 4 is a view used to describe control of relative movement around the Z axis of the optical probe and the candidate Object in the first embodiment;

FIG. 5 is a view used to describe adjustment of the viewpoint position of the optical probe in the first embodiment;

FIG. 6 is a simplified view of the configuration of the three-dimensional shape measuring apparatus in the first embodiment;

FIG. 7 is a block diagram of the three-dimensional shape measuring apparatus in the first embodiment;

FIG. 8 is a perspective view of the joystick in the first embodiment;

FIG. 9 is a flowchart showing switching of modes in the three-dimensional shape measuring apparatus in the first embodiment;

FIG. 10 is a simplified view of the configuration of the three-dimensional shape measuring apparatus in the second embodiment;

FIG. 11 is a block diagram of the three-dimensional shape measuring apparatus in the second embodiment;

FIG. 12 is a perspective view of the joystick in the second embodiment;

FIG. 13 is a view used to describe the tracking movement of the optical probe during fixed-viewpoint mode in the three-dimensional shape measuring apparatus of the second embodiment; and

FIG. 14 is a view used to describe adjustment of the viewpoint position of the optical probe in the second embodiment.

### DESCRIPTION OF THE EMBODIMENTS

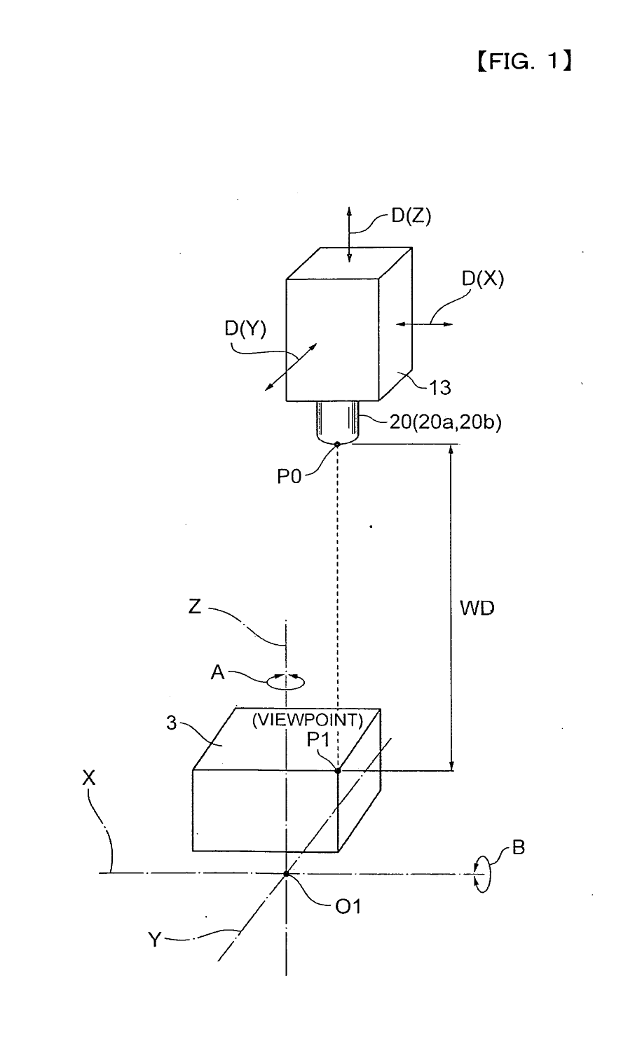

The following is a description of preferred embodiments of the present invention with reference to the drawings. First, a summary will be given, with reference to FIG. 1, of control of the relative movement of the measuring head 13 and the candidate object 3 supported by the support device of the three-dimensional shape measuring apparatus in the first embodiment of the present invention. By way of example, the candidate object 3 is the substantially rectangular member shown in FIG. 1. The operating principle of the shape measuring apparatus will be described with reference to FIG. 1, the apparatus being configured so as to image the surface of the candidate object 3 using a measuring head 13 (optical probe 20), and to measure the three-dimensional shape of the candidate object 3 from the resulting images.

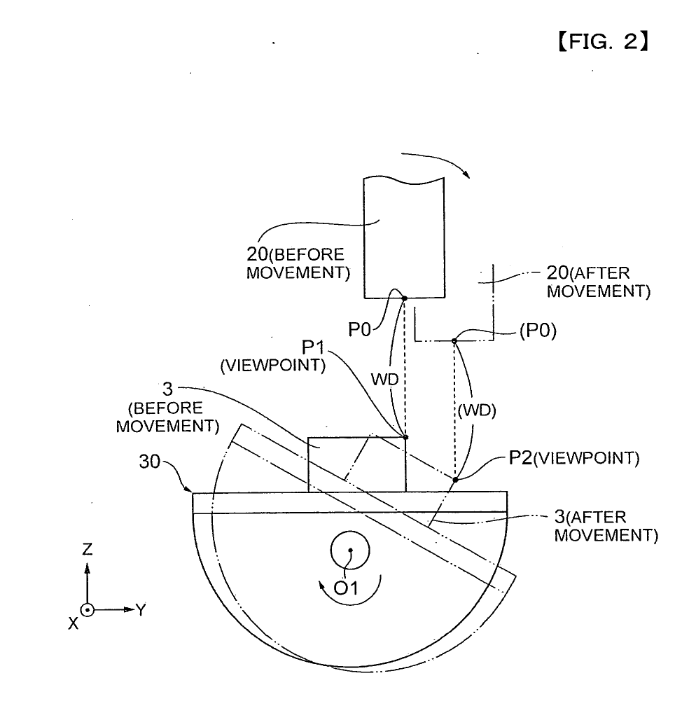

The shape measuring apparatus has a support device 30 for supporting the candidate object 3 (see FIG. 2). The support device 30 rotatably supports the candidate object 3 around the Z axis extending vertically (the rotation is indicated by arrow A), in which state the candidate object 3 is able to rotate around the X axis extending horizontally (left-right), perpendicular to the Z axis, and passing through point O1 on axis Z (the direction is indicated by arrow B). An optical probe 20 mounted on a measuring head 13 is arranged above the candidate object 3 thus supported by the support device 30 so that it is able to move left and right along the X axis (which movement is indicated by arrow D(X)), is able to move up and down along the Z axis (which movement is indicated by arrow D(Z)), and is able to move forward and backward along the Y axis perpendicular to the X axis and the Z axis (which movement is indicated by arrow D(Y)). This optical probe 20 has an illumination optical system for irradiating the candidate object 3 with light, an imaging optical system for imaging light from the candidate object 3 on an imaging plane, and an imaging plane composed of a solid-state imaging element such as a CCD. These are controlled by the control unit and the shape of the surface of the candidate object 3 is measured.

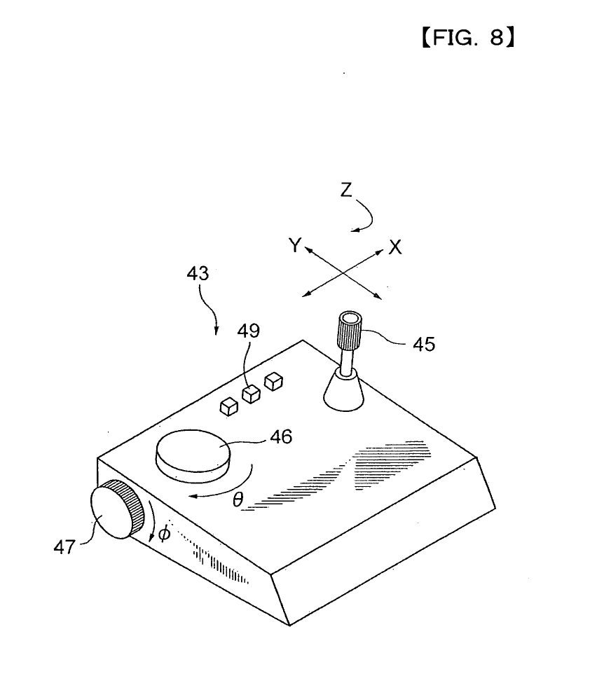

The movement of the optical probe 20 along the X, Y, and Z axes, and rotation of the candidate object 3 around the X and Z axes by the support device 30 are performed by operating a joystick 43 (see FIG. 8) serving as an operating device. Disposed in the joystick 43 are an operating lever 45 for moving the optical probe 20 along the X, Y, and Z axes, and a plurality of jog dials 46, 47 for rotating the support device 30 around the X and Z axes. By tilting and rotating the operating lever 45, the optical probe 20 can be moved along the X, Y, or Z axis. By rotating the jog dials 46, 47, the candidate object 3 can be rotated around the X or Z axis. The position of the optical probe 20 and the position of the support device (rotational position) moved by the operation of the joystick 43 are detected by the control unit used to control the entire three-dimensional shape measuring apparatus.

When the surface of the candidate object 3 so supported by the support device 30 is imaged and the desired measurement performed, the optical probe 20 and the candidate object 3 have to be positioned so that the distance between the end portion of the optical probe 20 and the viewing position of the candidate object 3 is at a predetermined work distance WD, and the viewpoint (observation point) located a work distance WD from the end portion of the optical probe 20 along the optical axis of the illuminating light has to be aligned with the target observation point of the candidate object 3. At this time, the direction in which the light is emitted from the optical probe 20 also has to be optimized for measurement relative to the target observation plane of the candidate object 3. Here, the work distance WD is the distance between the end portion of the probe 20 (point P0) and the candidate object 3 (the distance at which the image captured by the optical probe 20 comes into focus). The WD is set to a predetermined value based on such factors as the focal length of the imaging optical system.

At this time, for example, when the surface of the candidate object 3 is irradiated with light by the optical probe 20 at point P1 in the drawing (the target observation point), the position of the viewpoint set apart by a predetermined work distance WD from the distal end portion (point P0) of the optical probe 20 on the optical axis of the light from the optical probe 20 has to be positioned at the target observation point P1.

Thus, the operating lever 45 of the joystick 43 is operated so that the optical probe 20 is caused to move left and right along the X axis, forward and backward along the Y axis, and up and down along the Z axis in a combined operation. The distal end portion of the optical probe 20 (point P0) and the target observation point P1 for the candidate object 3 are thereby brought closer to positions set apart by a work distance WD, and the viewpoint of the optical probe 20 is brought into alignment with the target observation point P1.

Sometimes a portion of the candidate object 3 to be imaged with the imaging optical system will be hidden by the candidate object 3 itself due to the shape of candidate object 3, causing a so-called dead angle. In such a situation, the orientation of the optical probe 20 relative to the candidate object is adjusted in order to optimize the positional relationship between the observation optical system and the illumination optical system of the optical probe 20 and the candidate object 3. In order to make this adjustment, for example, the jog dials 46, 47 of the joystick 43 are operated to rotate the candidate object 3 around the X axis and the Z axis, and to move the target observation point P1 of the candidate object 3 away from the viewpoint of the optical probe 20. Therefore, in order to realign the viewpoint of the optical probe 20 with the target observation point, the operating lever 45 of the joystick 43 has to be operated in order to move and position the optical probe 20 along the X, Y, and Z axes. When at this point fine adjustments are made to the orientation of the optical probe 20 relative to the candidate object 3 by rotating the candidate object 3 around the X and Z axes, the target observation point and the viewpoint are shifted. As a result, the operation for aligning the position of the viewpoint with the target observation point, and the operation for adjusting the orientation of the optical probe 20 relative to the candidate object 3 are repeated.

Thus, the three-dimensional shape measuring apparatus in this embodiment has two operational control modes for controlling the relative movement of the optical probe 20 and the candidate object 3. In the first mode, as mentioned above, the relative movement of the optical probe 20 and the candidate object 3 along the X, Y, and Z axes and the relative rotation of the optical probe and candidate object around the X and Z axes are controlled based on the operation of the joystick 43 (in the description below, the first mode is referred to as the “normal operating mode”).

In the second mode, the significance of the joystick operation in the normal operating mode is changed. The position of the viewpoint is determined from the work distance WD and the measurement vector of the optical probe 20 (the direction from the optical probe to the viewpoint, which is always straight down in this embodiment), and the relative movement of the optical probe 20 and the candidate object 3 (X, Y, and Z movement) is controlled so that the viewpoint changed by the relative rotation of the optical probe 20 and the candidate object 3 using the joystick 43 never changes (remains fixed) on the imaging plane (in the description below, the second mode is referred to as the “fixed-viewpoint mode”).

For example, as shown in FIG. 2, when the dial 47 on the joystick 43 is operated to rotate the candidate object 3 around the X axis from a state in which the viewpoint of the optical probe 20 is aligned with the target observation point P1 of the candidate object 3, point P1 on the candidate object 3 which had been the viewpoint is moved to point P2 by the rotation. However, in the fixed-viewpoint mode, the viewpoint of the optical probe 20 is moved along the Y and Z axes so as to track the rotational movement of the candidate object 3, and the posture of the candidate object 30 is controlled so that this viewpoint matches point P2.

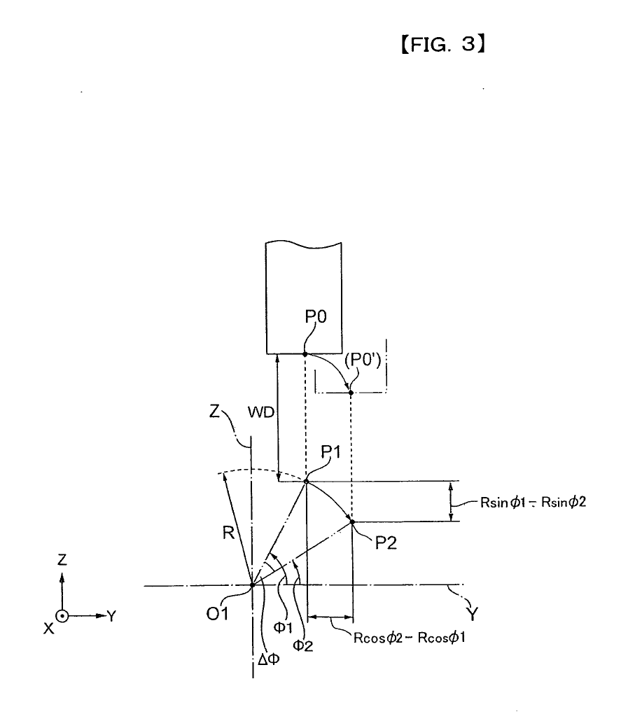

More specifically, as shown in FIG. 3, the position of the viewpoint of the optical probe 20 is determined to be the position (point P1) a work distance WD from the position (point P0) of the end portion of the optical probe 20 in the direction of the measurement vector (downward) as detected by the control unit. Here, the coordinates of point P0 are expressed as (C, Y1, Z1), and the coordinates of point P1 are expressed as (U, Y1, Z1−WD). When the candidate object 3 is rotated around the X axis by angle Δφ (=φ₁−φ₂) from angle φ₁ to angle φ₂, the rotational angle Δφ is detected by the control unit, and the size of angle φ₁ and the radius or rotation R are calculated from the coordinates of the rotational center O1 and the coordinates of point P1. The size of angle φ₂ is calculated from φ₁−Δφ. Therefore, in order to move the viewpoint of the optical probe 20 from point P1 to point P2 along with the rotational movement of the candidate object 3, movement control (viewpoint fixing control) is performed to displace the optical probe 20 R cos φ₂−R cos φ₁ along the Y axis and R sin φ₁−R sin φ₂ along the Z axis.

In this movement control, the optical probe 20 can be moved linearly from P1 to point P2 separately along the Y axis and the Z axis, or simultaneous biaxial movement can be performed linearly or arcuately along the Y and Z axes. By performing the viewpoint fixing control mentioned above in a very short period of time, the target observation point (target point) always appears in the same position in the images obtained on the imaging plane.

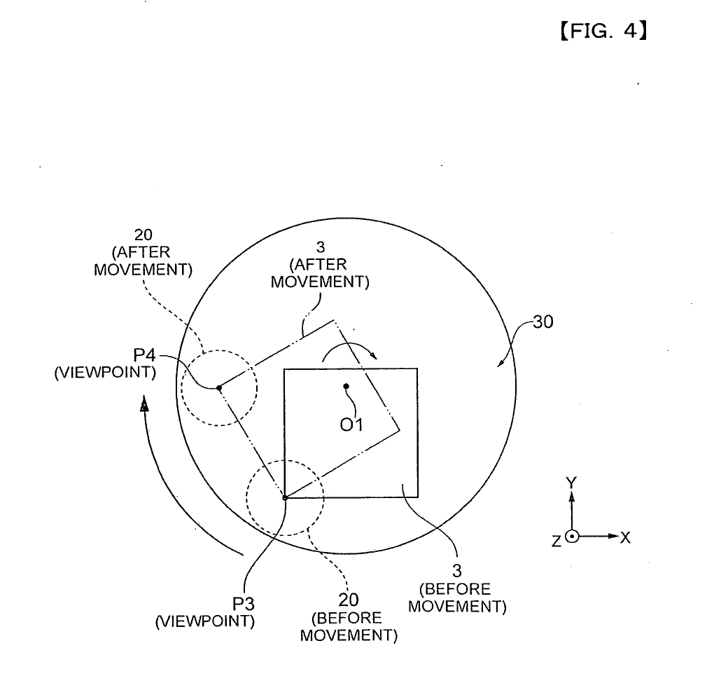

Similarly, as shown in FIG. 4, when the jog dial 46 on the joystick 43 is operated to rotate the candidate object 3 around the Z axis on the horizontal plane from a state in which the viewpoint of the optical probe 20 is aligned with the target observation point P3 of the candidate object 3, point P3 on the candidate object 3 which had been the viewpoint is moved to point P4. However, in the fixed-viewpoint mode, the viewpoint of the optical probe 20 is moved along the X and Y axes so as to track this movement, and is positioned so as to match point P4. In this situation, the optical probe 20 can be moved along the X and Y axes based on the rotational movement of the candidate object 3 while maintaining the position of the optical probe 20 along the Z axis. At this time, the optical probe 20 can be moved from P3 to point P3 separately along the X axis and the Y axis, or simultaneous biaxial movement can be performed linearly or arcuately along the X and Y axes.

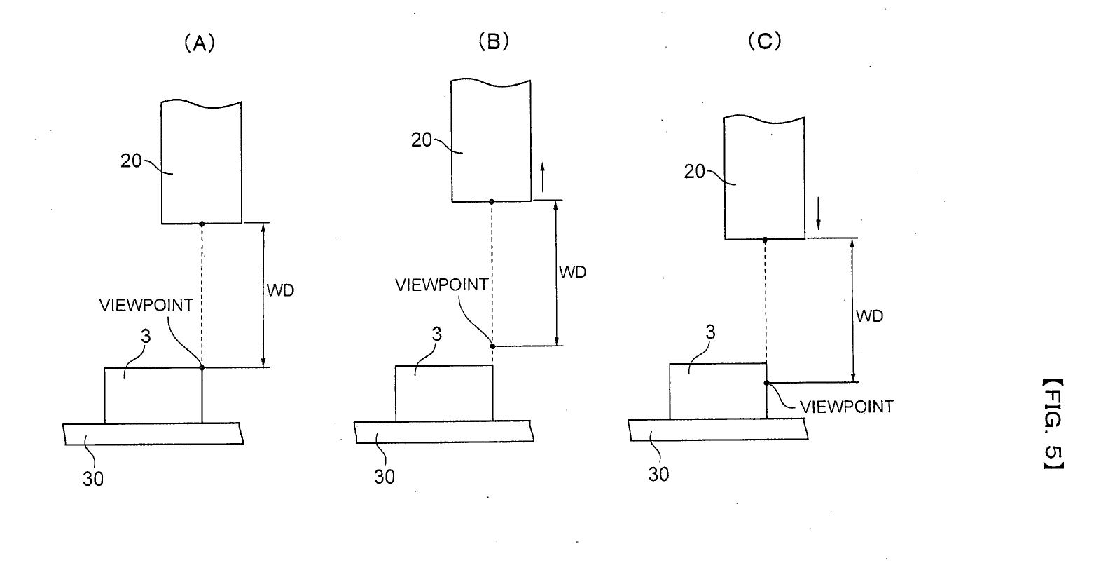

Also, in the fixed-viewpoint mode, when the viewpoint is shifted from the target observation point and unfocused, the position of the viewpoint can be adjusted for the optical probe 20 as shown in FIG. 5. Here, the viewpoint of the optical probe 20 can be moved up and down along the Z axis, or in the direction of the optical axis of the light (measurement vector) based how much the operating lever 45 has been operated.

In the fixed-viewpoint mode, the relative rotational movement of the optical probe 20 and the candidate object 3 can be performed while keeping the viewpoint aligned with the target observation point. This facilitates the positioning operation for measurements.

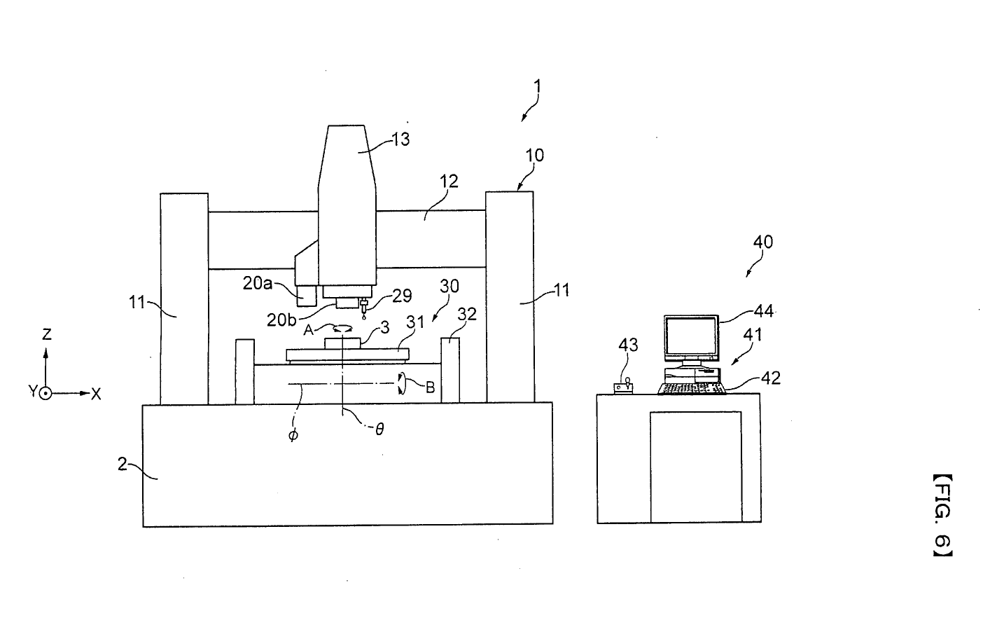

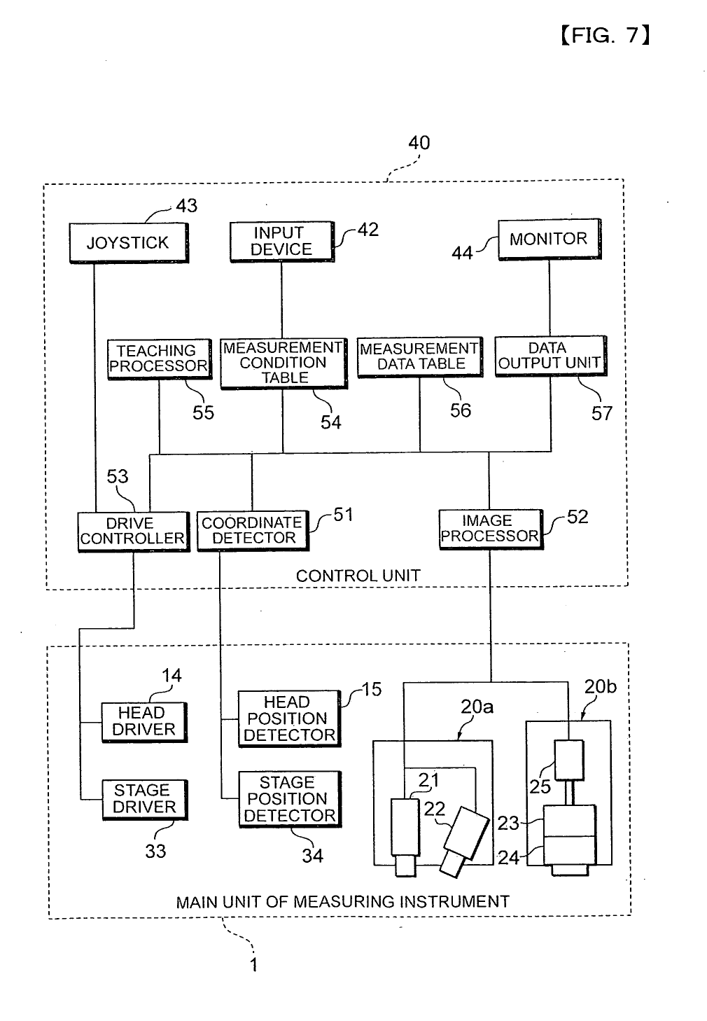

The specific configuration of a three-dimensional shape measuring apparatus based on the operating principles described above will now be described with reference to FIG. 6 and FIG. 7. Here, a simplified view of the configuration of the three-dimensional shape measuring apparatus in this embodiment is shown in FIG. 6, and a block diagram of the three-dimensional shape measuring apparatus is shown in FIG. 7. This three-dimensional shape measuring apparatus is composed primarily of a main unit 1 and a control unit 40.

As shown in FIG. 6, the main unit 1 is primarily composed of a horizontal base 2, a gantry structure 10 disposed on the base 2 for supporting a measuring head 13, and a support device 30 disposed on the base 2 on which a candidate object 3 is mounted.

The gantry structure 10 has pillars 11, 11 disposed on the base 2 so as to be able to move along the Y axis (the front and back direction perpendicular to the plane of the paper) along guide rails (not shown in the drawing) disposed so as to extend along the Y axis, a horizontal frame 12 extending horizontally so as to bridge the pillars 11, 11, and a measuring head 13 disposed so as to move along the Z axis (up and down) relative to a carriage (not shown in the drawing) disposed so as to move along the horizontal frame 12 in the direction of the X axis (left and right).

On the gantry structure 10, as shown in FIG. 7, are disposed a head driver 14 for moving the measuring head 13 electrically in the three directions (X, Y, and Z directions) based on inputted drive signals, and a head position detector 15 for detecting the coordinates of the measuring head 13 and outputting signals indicating the coordinate values of the measuring head 13. The head driver 14 has a Y axis motor for driving the pillars 11 in the Y direction, an X axis motor for driving the carriage in the X direction, and a Z axis motor for driving the measuring head 13 in the Z direction. The head position detector 15 has an X axis encoder, a Y axis encoder, and a Z axis encoder for detecting the position of the measuring head 13 along the X axis, the Y axis, and the Z axis.

The support device 30 has a stage 31 on which a candidate object 3 is mounted, and a support table 32 disposed on the base 2 for supporting the stage 31 so that it can be rotated within the horizontal plane around rotational axis a extending perpendicularly (along the Z axis) and so that it can be rotated (tilted) around rotational axis y extending horizontally (along the X axis).

As shown in FIG. 7, disposed in the support device 30 are a stage driver 33 for rotating the stage 31 around the rotational axes θ, φ based on inputted drive signals, and a stage position detector 34 for detecting the coordinates of the stage 31, and outputting signals indicating the stage coordinate values. The stage driver 33 has a rotary axis motor and a tilt axis motor for rotating the stage 31 around the rotational axes θ, φ. The stage position detector 34 has a rotary axis encoder and a tilt axis encoder for detecting the rotational position of the stage 31 around the rotational axes θ, φ.

The measuring head 13 has three measuring probes: an light sectioning probe 20a, an SFF probe 20a, and a touch probe 29. These probes 20a, 20b, 29 can be controlled separately, and are selected based on the shape characteristics of the candidate object 3.

The light sectioning probe 20a determines the surface shape of a candidate object using the light sectioning method. As shown in FIG. 7, the light sectioning probe 20a has a slit light illumination unit 21 for illuminating the candidate object with a slit light in the shape of a sheet, and a CCD camera 22 whose optical axis is arranged at a predetermined angle relative to the direction of the slit light from the slit light illumination unit 21 for imaging the light sectioning lines on the surface of the candidate object based on its cross-sectional shape. With the light sectioning probe 20a, the surface shape of a candidate object 30 can be determined by irradiating the candidate object with light from the slit light illumination unit 21, images taken by the CCD camera of the light sectioning lines formed on the surface of the candidate object based on its cross-sectional shape are processed by the image processor described below, the position data for each pixel in the images is calculated geometrically using the principles 22 of triangulation and based on the positional relationship between the slit light illumination unit 21 and the CCD camera 22, and the surface shape of the candidate object 3 is determined by scanning in a predetermined direction the slit light (light sectioning probe 20a) irradiating the candidate object. The state of the imaged position on the candidate object 3 can be observed using the CCD camera 22 by illuminating the candidate object 3 with light other than slit light (e.g., diffuse illumination).

The SFF probe 20b determines the surface shape of a candidate object using the shape-from-focus (SFF) method. As shown in FIG. 7, the probe has, in addition to an epi-illumination optical system 23, an imaging optical system 24 for imaging light from a candidate object, and a CCD camera 25 for detecting an image of the candidate object taken by the imaging optical system 24 (i.e., imaging a portion of the candidate object), and for outputting signals corresponding to the light intensity distribution of the detected image. An autofocus function is mounted in the SFF probe 20b so the relative distance between the optical probe 20b and the candidate object can be changed along the Z axis, and the candidate object 3 can be automatically focused. The following is a brief description of the principles of the SFF method. In this method, the candidate object 3 is irradiated with a predetermined planar pattern of light from the epi-illumination optical system 23, and an image of the candidate object is obtained by the CCD camera 25 every predetermined distance while the SFF probe 20b and the candidate object are moved relative to each other along the Z axis (in the focus direction). A spatial filter (differential operation) is applied to the resulting images by the image processor described below to determine the focus measure of each pixel, and shape information on the surface of the candidate object is obtained. By changing the positional relationship between the optical probe 20b and the candidate object, and calculating the position with the maximum focus measure (contrast) among the pixels of the candidate object (i.e., the focus position), the surface shape of the candidate object can be determined.

The touch probe 29 measures the surface shape of a candidate object based on the measurement coordinate values and measurement direction (direction in which the touch probe 29 moves) when the touch probe 29 makes contact with the candidate object. It is used on candidate objects that are difficult to measure using imaging measurements with the light sectioning probe 20a or SFF probe 20b.

A description of the touch probe 29 has been omitted below. Also, regardless of whether the light sectioning probe 20a or the SFF probe 20b in the measuring head 13 is used, both are referred to simply as the optical probe 20 in the description despite the operating principles described above.

As shown in FIG. 7, the control unit 40 has a coordinate detector 51 to which electric signals from the position detectors 15, 34 are inputted, an image processor 52 to which electric signals from the light sectioning probe 20a and the SFF probe 20b (CCD cameras 22, 25) are inputted, a drive controller 53 for controlling the drivers 14, 33, as well as the magnification and light level of the optical systems for the optical probe 20, a measurement condition table 54, a teaching processor 55 having teaching functions such as teaching, storage, and reproduction of the measurement procedures, a measurement data table 56, and a data output unit 57 for outputting measurement data. As shown in FIG. 6, the control unit 40 is configured as a computer system composed of a computer 41 having a CPU (central processing unit), an input device 42 such as a keyboard for inputting various types of instruction information, a joystick 43 for controlling the movement of the measuring head 13 and the stage 31, and a monitor 44 for displaying a measurement screen, instruction screen, and measurement results.

The coordinate detector 51 detects the positions of the probes 20a, 20b and the stage 31, or the observation position in the horizontal direction (the optical axis position) and the observation position in the vertical direction (focal position, etc.), using the coordinate signals outputted from the head position detector 15 and the stage position detector 34. It also detects the relative movement route and rate of movement for the probes 20a, 20b and the stage 31 in the same manner.

The image processor 52 is configured to process the electric signals outputted from the various pixels of the CCD cameras 22, 25 in the optical probes 20, and output image signals for displaying an image of the candidate object 3 on the screen of a monitor 44 to the monitor 44 via the data output unit 57. The image processor 52 is also configured to calculate the coordinate values of the measurement points based on the image information obtained by processing the electric signals outputted from the CCD cameras 22, 25 using the methods described above (the light sectioning method, the SFF method), and the coordinate values of the optical probes 20 and the stage 31 obtained from the coordinate detector 51 when an image is obtained. The results of this operation are then outputted successively to the measurement data table 56.

The drive controller 53 outputs drive signals to the head driver 14 and the stage driver 33, and controls the operation of the measuring head 13 (optical probes 20) and the stage 31 based on operating signals from the joystick 43 or based on instruction signals from the teaching processor 55.

As shown in FIG. 8, disposed inside the joystick 43 are an operating lever 45 for moving the measuring head 13 along the X, Y, and Z axes, jog dials 46, 47 for rotating the stage around the rotational axes θ, φ, and a viewpoint fixing switch 49 able to switch control of the relative movement of the measuring head 13 and the stage 31 between modes.

The operating lever 45, whose automatic return position is the upright position, can be tilted forward, backward, to the left and to the right. It can also be rotated around its axis. The jog dials 46, 47 can also be rotated around their axes. The viewpoint fixing switch 49 has a normal operating mode, which is the first mode described in the operating principles, and a fixed-viewpoint mode, which is the second mode. The viewpoint fixing switch 49 is configured to allow one of the two modes to be selected by turning the switch on and off.

When the viewpoint fixing switch 49 in the joystick 43 is turned on and off, the drive controller 53 switches between the two modes with respect to lever operations and dial operations performed with the joystick 43 to control the operation of the head driver 14 and the stage driver 33.

When the viewpoint fixing switch 49 is turned off, the drive controller 53 controls operating signals from the joystick 43 in the normal operating mode. In other words, when the operating lever 45 is tilted to the left or right from the upright position, the measuring head 13 is moved along the X axis. When tilted forward or backward from the upright position, the measuring head 13 is moved along the Y axis. When the operating lever 45 is rotated, the measuring head 13 is moved along the Z axis. When the jog dial 46 is rotated, the stage 31 is rotated around rotational axis θ. When the jog dial 47 is rotated, the stage 31 is tilted on rotational axis φ.

When the viewpoint fixing switch 49 is turned on, the drive controller 53 changes the significance of the joystick operations, and the operating signals from the joystick 43 are controlled according to the fixed-viewpoint mode. In the fixed-viewpoint mode, tilt operations by the operating lever 45 in the forward and reverse directions and in the left and right directions (X, Y operations) are disabled (ignored). Only the rotational operations of the operating lever 45 and the jog dials 46, 47 can be used. Here, when the jog dials 46, 47 are rotated, the stage 31 rotates around rotational axes θ, φ based on the amount of operation. The target position and rate of movement are calculated so that the viewpoint of the optical probe 20 tracks the rotation of the stage, and the movement of the measuring head 13 is controlled so that the target position is reached at the calculated rate of movement.

The tracking movement for (the viewpoint) of the optical probe 20 rotating around the rotational axis 8 as shown in FIG. 4 is enabled when an light sectioning probe 20a is used and the probe scanning direction is determined with respect to the orientation of the slit light. Here, the orientation of the candidate object 3 can be changed so as to be optimized with respect to the scanning direction of the light sectioning probe 20a.

When the operating lever 45 is rotated in the fixed-viewpoint mode, as shown in FIG. 5, the movement of the optical probe 20 (measuring head 13) along the Z axis is controlled in terms of the amount of movement and the rate of movement based on the amount the lever is operated so that the position of the viewpoint is adjusted while matching the measurement vector of the optical probe 20.

When the viewpoint position of the optical probe 20 is adjusted manually, the relative position of the optical probe 20 and the candidate object 3 is changed so that the contrast of the images of the candidate object 3 taken by the optical probe 20 and displayed on the monitor 44 is precise. However, if an indicator showing the contrast value of the image is installed and the operation is performed with reference to the indicator, the precision with which the viewpoint is positioned is improved and variations between operators eliminated. This indicator is preferably a graphic indicator in which the contrast value is displayed on the screen using a graphic image.

The measurement condition table 54 includes specific teaching data such as measuring conditions and measuring procedures, coordinate values such as the measurement start point (initial measurement point) and measurement end point (final measurement point) for a candidate object, target measurement direction at the measurement start point, and the interval between measurement points (e.g., a measurement pitch at a constant interval. This data is entered using, for example, the input device 42 and stored. Here, the coordinate values such as the measurement start point and the measurement end point for a candidate object 3, in addition to the entry of coordinate values using the input device 42, incorporates the coordinate values of previous measurement points obtained when the measuring head 13 and stage 31 are moved relative to each other by operating the joystick 43 and the candidate object 3 and the optical probe 20 are positioned in the desired posture. The measurement data acquisition range and the relative movement paths for the optical probe 20 and the candidate object 3 are determined by information such as the measurement start point and the measurement end point.

The teaching processor 55 sends movement instructions to the drivers 14, 33 via the drive controller 53 to move the measuring head 13 and the stage 31 along the movement path corresponding to the recorded measurement data acquisition range based on the teaching data recorded in the measurement condition table 54. The teaching processor 55 also inputs control signals to the drive controller 53 and controls the optical system of the optical probe 20 based on teaching data.

The measurement data table 56 stores point group data of coordinate values (three-dimensional coordinate values) for the various measurement points outputted from the image processor 52.

The data output unit 57 is used to output the measurement data (the coordinate values for all measurement points) stored in the measurement data table 56 after a measurement has been completed. This data can be outputted by being displayed on a monitor 44 or being printed out using a printer (not shown).

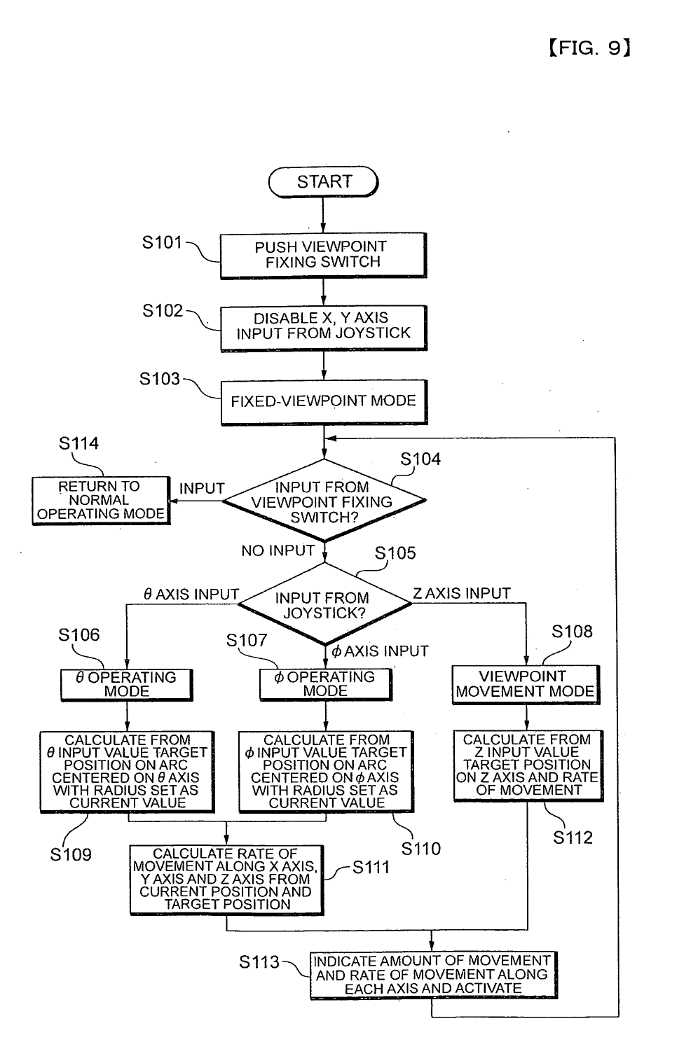

The following is a description with additional reference to FIG. 9 of the operations performed by a three-dimensional shape measuring apparatus with the aforementioned configuration during the change from the normal operating mode to the fixed-viewpoint mode.

First, during measurement of a candidate object 3 in the normal operating mode, the operating lever 45 of the joystick 43 is operated to move the optical probe 20 along the X, Y, and Z axes, and align the viewpoint of the optical probe 20 with the desired observation position on the candidate object 3. Afterwards, the viewpoint fixing switch 49 on the joystick 43 is turned on (Step S101). When the viewpoint fixing switch 49 has been turned on, movement of the optical probe 20 along the X and Y axes with the joystick 43 is disabled (Step S102), and the device is switched to fixed-viewpoint mode (Step S103).

It is then determined whether or not the viewpoint fixing switch 49 has been operated again (Step S104). If there is switch input due to the switch being turned off, the device returns to the normal mode (Step S114). If there is no switch input, the device remains in fixed-viewpoint mode. The significance of the joystick operations changes, and the relative movement of the optical probe 20 and the candidate object 3 is performed in the fixed-viewpoint mode by rotating the operating lever 45 and the jog dials 46, 47 on the joystick 43 (Step S105).

When the jog dial 46 on the joystick 43 is rotated in fixed-viewpoint mode (Step S106), the stage 31 is rotated around rotational axis θ based on the amount of rotation during the operation. Also, in order for the viewpoint position of the optical probe 20 to track the rotation of the stage 31, the target position for the viewpoint of the optical probe 20 is calculated from the amount of rotation by the stage 31 in an arcuate shape centered on the rotational axis θ and using the distance from the rotational axis θ to the current viewpoint position of the optical probe 20 as the rotation radius (Step S109).

When the jog dial 47 is rotated (Step S107), the stage 31 is rotated around rotational axis 9 based on the amount of rotation during the operation. Also, in order for the viewpoint position of the optical probe 20 to track the rotation of the stage 31, the target position for the viewpoint of the optical probe 20 is calculated from the amount of rotation by the stage 31 in an arcuate shape centered on the rotational axis φ and using the distance from the rotational axis φ to the current viewpoint position of the optical probe 20 as the rotation radius (Step S110).

Then, the rate of movement along the X, Y, and Z axes in the tracking movement of the optical probe 20 is calculated by the drive controller 53 from the current position and the target position of the viewpoint for the optical probe 20 (Step S111).

When the operating lever 45 of the joystick 43 is rotated (Step S108), the target position along the Z axis is calculated to adjust the viewpoint position and the rate of movement along the Z axis is calculated for the optical probe 20 based on the amount of rotation during the operation (Step S112).

Drive signals (amount of movement and rate of movement instructions for each axis) are outputted by the drive controller 53 to the head driver 14 and the stage driver 33 based on the operation of the joystick 43, and the measuring head 13 and the stage 31 are operated (Step S113). The relative movement of the measuring head 13 and the stage 31 are thus controlled in the fixed-viewpoint mode.

The following is a description of the process performed by a three-dimensional shape measuring apparatus configured as described above, when the three-dimensional shape of a candidate object 3 is to be measured automatically.

First, the viewpoint fixing switch 49 on the joystick 43 is operated, the device is switched to the normal operating mode or the fixed-viewpoint mode, the viewpoint of the optical probe 21 is aligned with the desired measurement start point (initial measurement coordinates) relative to the candidate object 3 mounted on the stage 31 based on the operation of the lever and dials on the joystick 43 to optimize the orientation of the optical probe 20 relative to the candidate object 3. An image with the measurement start point is obtained by the optical probe 20, the coordinate values for the measurement start point are calculated based on the image information (edge coordinate values, and the like) processed by the image processor 52 in the control unit 40, and the coordinate values of the optical probe 20 and the stage 31 outputted from the coordinate detector 51, and the coordinate values are incorporated Into the measurement condition table 54 and recorded.

Similarly, the joystick 43 is operated to switch modes and move the optical probe 20 and stage 31 relative to each other. The viewpoint of the optical probe 20 is aligned with the next target measurement point (pass through point) and the measurement end point (final measurement target point), the orientation of the optical probe 20 is aligned optimally for measurement with respect to the candidate object 3, and coordinate detection is performed on the measurement points. The coordinate values are recorded one by one in the measurement condition table 54, and measurement data acquisition range is determined.

The data acquisition range is thus set in the measurement condition table 54. Also, when the measurement pitch or other parameters are set in the measurement condition table 54 using the input device 42, the order is determined by the teaching processor 55 for obtaining measurement points and measurement data. In other words, the order for obtaining measurement data is the order in which measurement data is obtained so that the optical probe 20 and the stage 31 move relative to each other each time at the measurement pitch from the measurement start point to the measurement end point.

The teaching processor 55 controls the movement of the optical probe 20 and the stage 31 based on the coordinate values of the target measurement points incorporated into the measurement condition table 54, the measurement pitch set in advance in the measurement condition table 54, and the teaching data determined by the target measurement direction or the like. As the measurement point on the candidate object 3 changes along the measurement route from the measurement start point to the measurement end point, the three-dimensional coordinates (point group data) for the measurement points are obtained. The point group data is stored in the measurement data table 56.

When the point group data for all of the measurement points has been obtained, and the end of the measurement process has been detected, the data output unit 57 displays on a monitor 44 the point group data stored in the measurement data table 56 and the three-dimensional shape based on this point group data.

Because the three-dimensional shape measuring apparatus in this embodiment switches between two control modes, a normal operating mode and a fixed-viewpoint mode, based on the alignment when controlling the relative movement of the optical probe 20 and the candidate object 3, alignment can be performed easily using a joystick. Also, the number of times the optical probe 20 and the candidate object 3 have to be moved during the alignment process is reduced, and the time required for the three-dimensional shape measuring apparatus can be reduced.

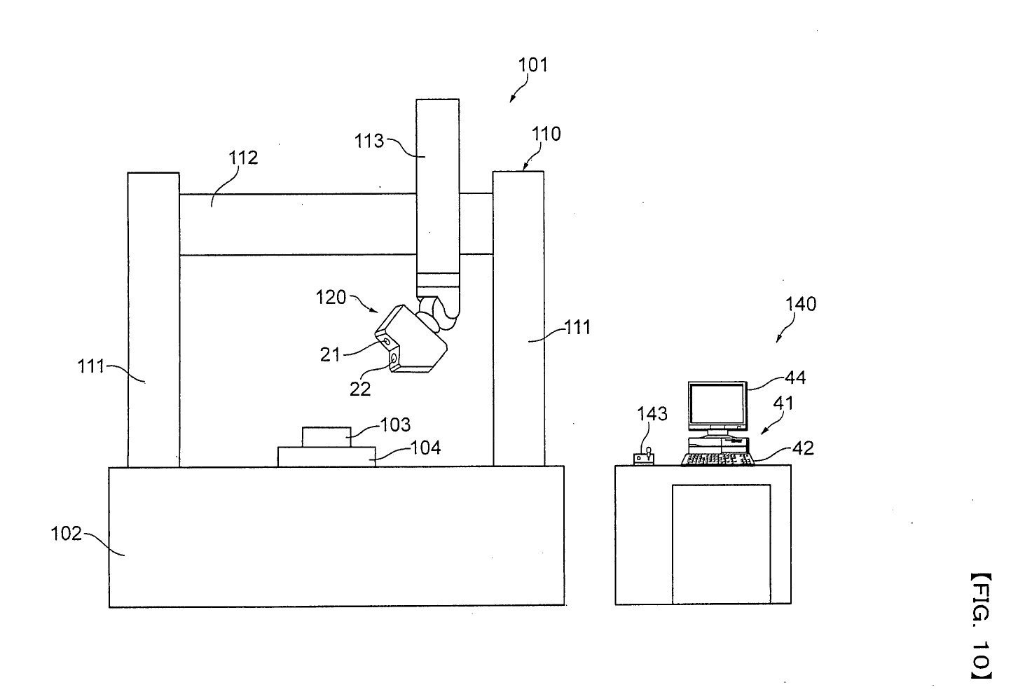

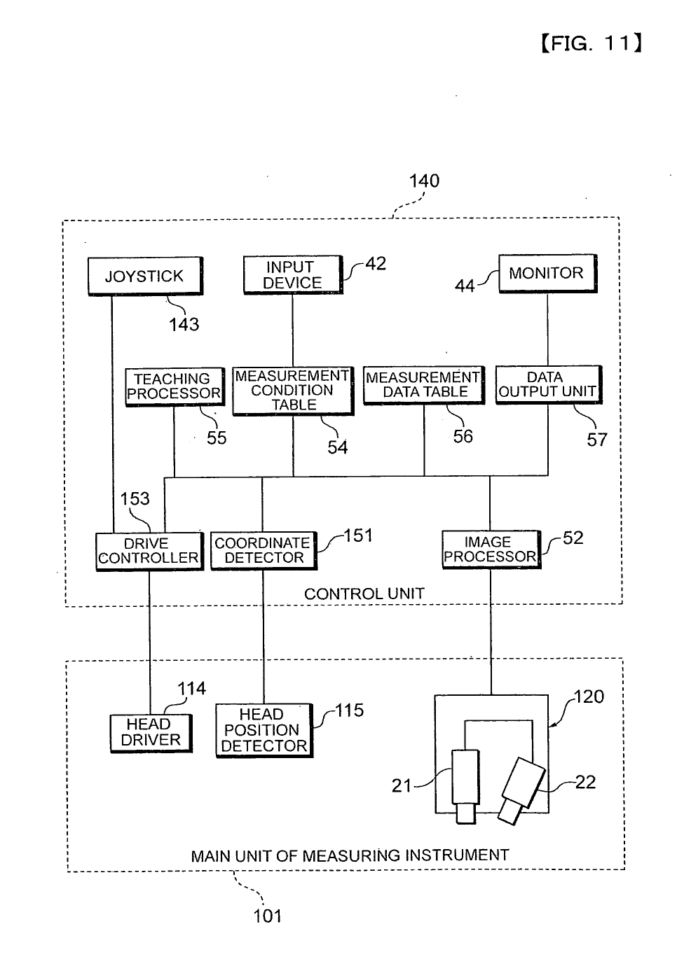

The following is a description of the three-dimensional measuring apparatus in the second embodiment. In this embodiment, the structural elements identical to those in the three-dimensional measuring apparatus of the first embodiment are denoted by the same reference numerals, and further description of these elements has been omitted. The following description will focus on the points of difference with the first embodiment. A simplified view of the configuration of the three-dimensional shape measuring apparatus in the second embodiment is shown in FIG. 10, and a block diagram of the three-dimensional shape measuring apparatus is shown in FIG. 11.

The three-dimensional shape measuring apparatus of the second embodiment, as shown in FIG. 10, is composed primarily of a main unit 101 and a control unit 140. The main unit 101 is primarily composed of a horizontal base 102 for supporting a candidate object 103 via a mounting jig 104 or the like, and a gantry structure 110 disposed on the base 102 for detachably supporting an optical probe 120.

The gantry structure 110 has pillars 111, 111 disposed on the base 102 so as to be able to move along the Y axis (the front and back direction perpendicular to the surface of the paper) along guide rails (not shown in the drawing) disposed so as to extend along the Y axis, a horizontal frame 112 extending horizontally so as to bridge the pillars 111, 111, and a measuring head 113 disposed so as to move along the Z axis (up and down) relative to a carriage (not shown in the drawing) disposed so as to move along the horizontal frame 112 in the direction of the X axis (left and right). An optical probe 120 such as an light sectioning probe or an SFF probe is detachably supported on the end portion (lower end portion) of the measuring head 113 via a clamp mechanism (not shown in the drawing). The optical probe 120 mounted on the measuring head 113 can thus be selected based on the shape characteristics of the candidate object 103. In FIG. 10, a light sectioning probe equipped with a slit light illumination unit 21 and a CCD camera 22 is mounted.

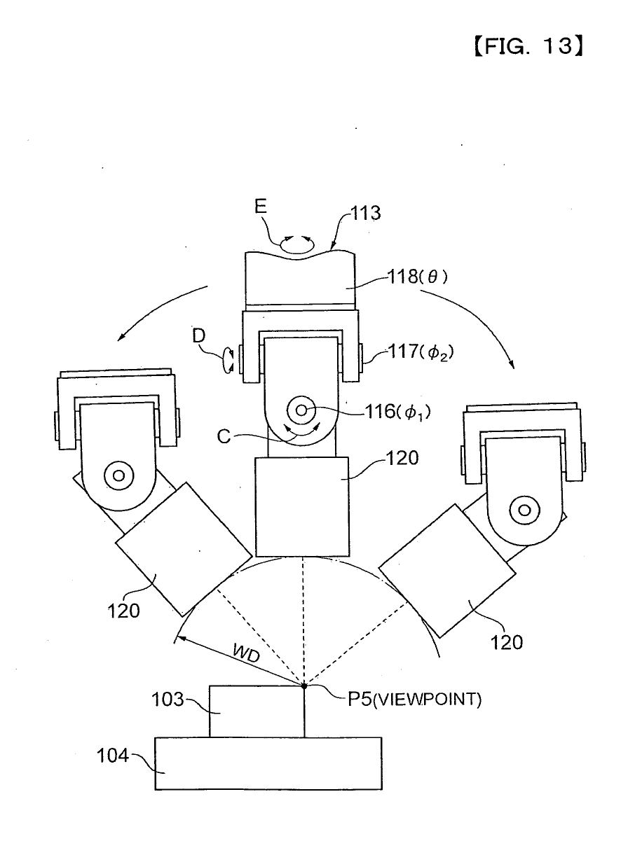

Also, as shown in FIG. 13, a three-axis rotation mechanism is disposed in the measuring head 113. Here, the optical probe 120 is supported so as to be able to rotate around a rotational axis 116 (φ₄) extending horizontally (the rotation is indicated by arrow C), the optical probe 120 is supported so as to be able to rotate around a rotational axis 117 (φ₂) extending in the direction perpendicular to rotational axis 16 (the rotation is indicated by arrow D), and the optical probe 120 is supported so as to be able to rotate around a rotational axis 118 (θ) extending parallel to the Z axis extending vertically (the rotation is indicated by arrow E).

On the gantry structure 110, as shown in FIG. 11, are disposed a head driver 114 for moving the measuring head 113 electrically in the three directions (X, Y, and Z directions) and moving the optical probe 120 electrically around the rotational axes 116 (φ₁), 117 (φ₂), 118 (θ) based on inputted drive signals, and a head position detector 115 for detecting the X, Y, Z coordinates of the measuring head 113 and the θ, φ₁, φ₂ coordinates of the optical probe 120, and outputting signals indicating the coordinate values of the measuring head 113 and the optical probe 120. The head driver 114 has a Y axis motor for driving the pillars 111 in the Y direction, an X axis motor for driving the carriage in the X direction, a Z axis motor for driving the measuring head 113 in the Z direction, and a first through third rotary motor for rotating the optical probe 120 around the θ, φ₁, φ₂ rotational axes. The head position detector 115 has an X axis encoder, Y axis encoder, and Z axis encoder for detecting the position of the measuring head 113 along the X axis, the Y axis, and the Z axis, and a first through third rotary encoder for detecting the rotational position of the optical probe 120 around the θ, φ₁, φ₂ rotational axes.

As shown in FIG. 11, the control unit 140 has a coordinate detector 151 to which electric signals from the head position detector 115 are inputted, an image processor 52 to which electric signals from the optical probe 120 (CCD camera) are inputted, a drive controller 153 for controlling the head driver 114 as well as the magnification and light level of the optical systems for the optical probe 120, a measurement condition table 54, a teaching processor 55 having teaching functions such as teaching, storage, and reproduction of the measurement procedures, a measurement data table 56, and a data output unit 57 for outputting measurement data.

The coordinate detector 151 detects the position (three-dimensional coordinate values) and the rotational orientation (rotational angles) of the optical probe 120, and also detects the movement route and rate of movement of the optical probe 120 according to an electronic signal input from the head position detector 115.

The drive controller 153 outputs drive signals to the head driver 114 and controls the operation of the measuring head 113 based on operating signals from the joystick 143 or based on instruction signals from the teaching processor 55.

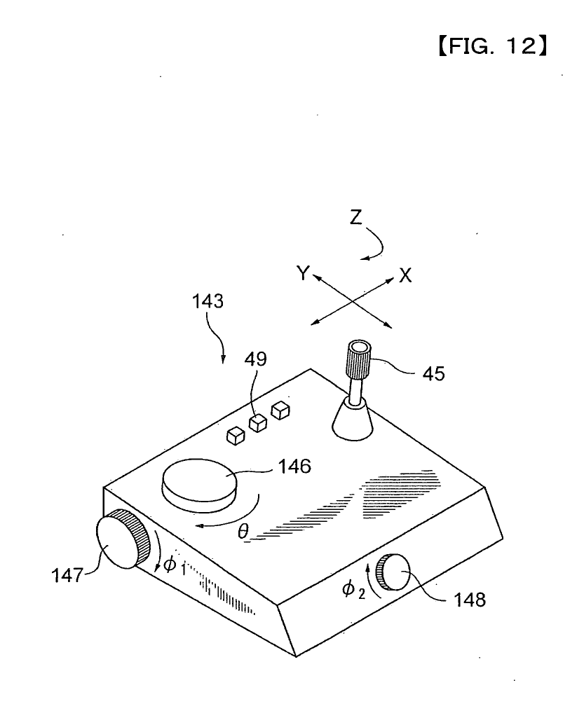

As shown in FIG. 12, disposed inside the joystick 143 are an operating lever 45 for moving the measuring head 113 along the X, Y, and Z axes, jog dials 146, 147, 148 for rotating the optical probe 120 around the rotational axes φ₁, φ₂, θ, and a viewpoint fixing switch 49 able to switch control of the movement of the measuring head 113 between modes.

When the viewpoint fixing switch 49 in the joystick 143 is turned on and off, the drive controller 153 switches between the two modes; i.e., the normal operating mode and fixed-viewpoint mode, with respect to lever operations and dial operations performed with the joystick 143 to control the operation of the head driver 114.

When the viewpoint fixing switch 49 is turned off, the drive controller 153 controls operating signals from the joystick 143 in the normal operating mode. In other words, when the operating lever 45 is tilted forward or backward from the upright position, the measuring head 113 is moved along the X axis. When tilted left or right from the upright position, the measuring head 113 is moved along the Y axis. When the operating lever 45 is rotated, the measuring head 113 is moved along the Z axis. When the jog dial 146 is rotated, the optical probe 120 is rotated around rotational axis 118 (θ). When the jog dial 147 is rotated, the optical probe 120 is rotated around rotational axis 116 (φ₁). When the jog dial 148 is rotated, the optical probe 120 is rotated around rotational axis 117 (φ₂).

When the viewpoint fixing switch 49 is turned on, the drive controller 153 changes the significance of the joystick operations, and the operating signals from the joystick 143 are controlled according to the fixed-viewpoint mode. In the fixed-viewpoint mode, tilt operations by the operating lever 45 in the forward and reverse directions and in the left and right directions (X, Y operations) are disabled (disregarded). Only the rotational operations of the operating lever 45 and the jog dials 146, 147, 148 can be used.

In the fixed-viewpoint mode, when the imaging direction (optical axis of the imaging optical system) of the optical probe 120 is aligned with the Z axis and the jog dial 146 is rotated, the viewpoint position does not change with the rotation of the optical probe 120 around rotational axis 118 (rotation in the horizontal plane). As a result, tracking movement control along the X, Y, and Z axes is not performed for the optical probe 12 in response to the rotational movement. When an light sectioning probe is used, this rotational movement is performed when the orientation of the sheet light changes.

When the jog dial 147 is rotated, as shown in FIG. 13, the optical probe 120 is rotated around rotational axis 116 (φ₁) in response to the operated amount. With the viewpoint position fixed (point P5), the optical probe 120 swings in the plane perpendicular to rotational axis 116 along an arc centered on the viewpoint and having a diameter equal to the work distance WD. The viewpoint of the optical probe 120 is thus not changed by the rotation of the optical probe 120 around rotational axis 116. The orientation of the optical probe 120 is also optimized relative to the candidate object 103 while a predetermined work distance WD is maintained between the optical probe 120 with respect to the target observation point P5 of the candidate object 103.

When the jog dial 148 is rotated and the optical probe 120 is rotated around rotational axis 117 (φ₂), the tracking movement controls are the same as those described above. Thus, further description has been omitted. Because rotational axis 116 and rotational axis 117 extend in directions that are perpendicular to each other, the axial direction of rotational axis 116 and rotational axis 117 are aligned with rotational axis 118 in the same manner when rotated by 90 degrees.

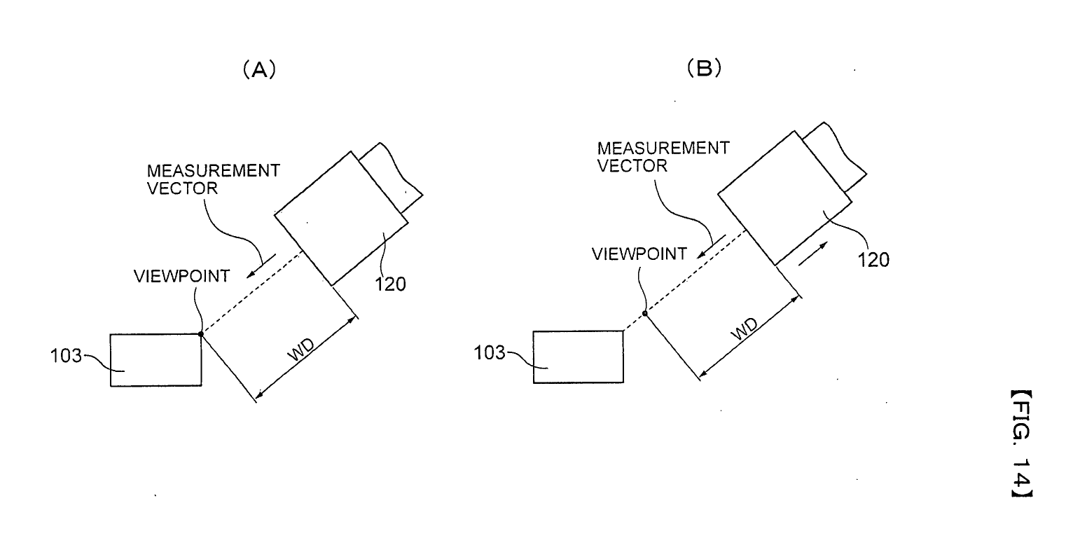

When the operating lever 45 of the joystick 143 is rotated, as shown in FIG. 14, a drive control is performed so that the viewpoint position can be adjusted while the measurement vector of the optical probe 120 is kept in alignment, and so that the optical probe 120 can move along the measurement vector towards or away from the former viewpoint position. In this way, the viewpoint position can be adjusted while maintaining the same measurement vector.

Because the three-dimensional shape measuring apparatus in the second embodiment switches between two control modes, a normal operating mode and a fixed-viewpoint mode, based on the target alignment when controlling the relative movement of the optical probe 120 and the candidate object 103, alignment can be performed easily using a joystick. Also, the number of times the optical probe 120 and the candidate object 103 have to be moved during the alignment process is reduced, and the time required for the three-dimensional shape measuring apparatus can be reduced.

In these embodiments, the optical probes mounted in the measuring head used the light sectioning method or the SFF method. However, the technical scope of the present invention is not limited to the embodiments described above. Optical probes using other methods such as the confocal system or the shape-from-defocus (SFD) method can be employed. A one-dimensional or two-dimensional solid-state imaging element such as a CMOS can also be used as the imaging element.

### EXPLANATION OF NUMERALS AND CHARACTERS

1 main unit of measuring instrument (first embodiment)
2 horizontal base
3 candidate object
10 gantry structure (movement device)
11 pillar
12 horizontal frame
14 head driver (drive mechanism)
20 optical probe (measuring probe)
30 support device
31 stage (support device, stage portion)
33 stage driver
43 joystick
52 image processor
53 drive controller
101 main unit of measuring instrument (second embodiment)
102 horizontal base
103 candidate object
114 head driver
120 optical probe
143 joystick
153 drive controller
WD work distance

1. A shape measuring apparatus configured so that a measuring probe is caused to move in a relative manner with respect to a candidate object, and a three-dimensional shape of the candidate object is measured in a non-contact manner from information obtained by the measuring probe,
the shape measuring apparatus comprising:
a movement device for moving the measuring probe to a desired position with respect to the candidate object, and
a support device for rotating the candidate object around at least two rotational axes.

2. The shape measuring apparatus according to claim 1, the support device having a stage portion on which the candidate object is mounted, wherein causing the stage portion to rotate around a first rotational axis extending perpendicular to the mounting plane enables the candidate object to be rotated within a horizontal plane, and causing the stage portion to rotate through the first rotational axis and around a second rotational axis perpendicular to the first rotational axis enables the candidate object to be tilted relative to the horizontal plane.

3. The shape measuring apparatus according to claim 1, wherein the movement device has a drive mechanism for translating the measuring probe along three mutually perpendicular axes.

4. The shape measuring apparatus according to claim 3, wherein the movement device comprises:
a base for holding the support device,
a pillar able to move along an in-plane direction of a holding surface on the base,
a frame extending in a direction perpendicular to a direction in which the pillar is able to move and extending in a direction parallel to the in-plane direction, and
a carriage for holding the measuring probe movably in a direction perpendicular to the moving direction and the extending direction, the carriage being able to move in the extending direction of the frame,
the pillar, carriage, and measuring probe being driven by the drive mechanism.

5. The shape measuring apparatus according to claim 1, wherein the measuring probe comprises a camera and an image processor for processing a signal outputted from the camera, the camera having an image optics system for taking an image of the candidate object.

6. The shape measuring apparatus according to claim 1, wherein the measuring probe comprises an light sectioning probe having a slit light illumination unit for irradiating the candidate object with a slit light in the form of a sheet, and a camera for imaging the candidate object illuminated by the slit light, the camera being arranged with an optical axis offset by a predetermined angle relative to the direction of irradiation of the slit light.

7. A shape measuring apparatus comprising:
a support device on which a candidate object is mounted,
an imaging device for illuminating the candidate object mounted on the support device, receiving light from the candidate object, and imaging the candidate object,
a measurement processor for measuring the candidate object based on an image of the candidate object taken by the imaging device,
a movement mechanism for supporting the support device and the imaging device to enable at least three relative movements among relative rotational movement around three mutually perpendicular axes and relative translational movement along the three axes, and
an operation control device for controlling the relative movement of the support device and the imaging device,
the operation control device having a first operational control mode for controlling the relative movement of the imaging device and the support device in order for the imaging device to scan an imaged portion of the candidate object, and a second operational control mode for controlling the relative movement of the imaging device and the support device while maintaining a state in which the imaging device can image the imaged portion.

8. The shape measuring apparatus according to claim 7, further comprising an operating device for operating the movement mechanism via the operation control device, wherein the operation control device is configured so as to control, based on an operating signal from the operating device, the relative movement governed by the first or second operational control mode.

9. The shape measuring apparatus according to claim 7, wherein the operation control device is configured so as to control, in the second operational control mode, the relative movement while a work distance is kept constant, the work distance being a distance between the imaging device and a position for viewing the candidate object.

10. The shape measuring apparatus according to claim 7, wherein the movement mechanism comprises a translational movement mechanism for supporting the imaging device to allow translational movement along the three axes, and a rotational movement mechanism for supporting the support device to allow rotational movement around at least two of the three axes.

11. The shape measuring apparatus according to claim 7, wherein the movement mechanism comprises a translational movement mechanism for supporting the imaging device to enable translational movement along the three axes, and a rotational movement mechanism for supporting the imaging device to enable rotational movement around a predetermined axis among the three axes, and to enable rotational movement around a rotational axis extending within a plane perpendicular to the predetermined axis and which is rotationally displaced within the plane accompanying rotation around the predetermined axis.

12. The shape measuring apparatus according to claim 2, wherein the movement device has a drive mechanism for translating the measuring probe along three mutually perpendicular axes.

13. The shape measuring apparatus according to claim 2, wherein the measuring probe comprises a camera and an image processor for processing a signal outputted from the camera, the camera having an image optics system for taking an image of the candidate object.

14. The shape measuring apparatus according to claim 3, wherein the measuring probe comprises a camera and an image processor for processing a signal outputted from the camera, the camera having an image optics system for taking an image of the candidate object.

15. The shape measuring apparatus according to claim 2, wherein the measuring probe comprises an light sectioning probe having a slit light illumination unit for irradiating the candidate object with a slit light in the form of a sheet, and a camera for imaging the candidate object illuminated by the slit light, the camera being arranged with an optical axis offset by a predetermined angle relative to the direction of irradiation of the slit light.

16. The shape measuring apparatus according to claim 3, wherein the measuring probe comprises an light sectioning probe having a slit light illumination unit for irradiating the candidate object with a slit light in the form of a sheet, and a camera for imaging the candidate object illuminated by the slit light, the camera being arranged with an optical axis offset by a predetermined angle relative to the direction of irradiation of the slit light.

17. The shape measuring apparatus according to claim 8, wherein the operation control device is configured so as to control, in the second operational control mode, the relative movement while a work distance is kept constant, the work distance being a distance between the imaging device and a position for viewing the candidate object.

18. The shape measuring apparatus according to claim 8, wherein the movement mechanism comprises a translational movement mechanism for supporting the imaging device to allow translational movement along the three axes, and a rotational movement mechanism for supporting the support device to allow rotational movement around at least two of the three axes.

19. The shape measuring apparatus according to claim 9, wherein the movement mechanism comprises a translational movement mechanism for supporting the imaging device to allow translational movement along the three axes, and a rotational movement mechanism for supporting the support device to allow rotational movement around at least two of the three axes.

20. The shape measuring apparatus according to claim 8, wherein the movement mechanism comprises a translational movement mechanism for supporting the imaging device to enable translational movement along the three axes, and a rotational movement mechanism for supporting the imaging device to enable rotational movement around a predetermined axis among the three axes, and to enable rotational movement around a rotational axis extending within a plane perpendicular to the predetermined axis and which is rotationally displaced within the plane accompanying rotation around the predetermined axis.
